(19) United States
(12) Patent Application Publication
(10) Pub. No.: US 2026/0342803 A1
(43) Pub. Date: Oct. 29, 2026

(54) SYSTEM AND METHOD FOR MULTI-CLOUD GOVERNANCE AND PROTECTION INCLUDING ZERO-LATENCY ENTITLEMENT RECONCILIATION

(71) Applicant: ORACLE INTERNATIONAL CORPORATION, Redwood Shores, CA (US)

(72) Inventors: KUMAR SETHI, Hansi (IN); CHUNI KUKREJA, Delhi (IN); SALONI ARORA, Haridwar (IN); ANKUR SINGH, Delhi (IN)

(21) Appl. No.: 19/192,956

(22) Filed: Apr. 29, 2025

(51) Int. Cl. H04L 9/40

(52) U.S. Cl. CPC H04L 63/105; H04L 63/0435; H04L 63/20

(57) ABSTRACT

In accordance with an embodiment, described herein is a system and method for multi-cloud governance and protection including zero-latency entitlement reconciliation. The system can be used to address entitlement propagation delays in multi-cloud environments, by leveraging quantum computing techniques and zero-latency synchronization to provide instant updates to permissions and roles across one or more cloud environments while maintaining security for access logs and audit trails. Embodiments described herein can be used to support applications across various technologies, such as cloud infrastructure entitlement management (CIEM), cloud security posture management (CSPM), or cloud native application protection platform (CNAPP), while providing faster, secure, and highly-scalable cloud governance capabilities.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described here are generally related to cloud computing environments, and are particularly directed to systems and methods for multi-cloud governance and protection including zero-latency entitlement reconciliation.

### BACKGROUND

Within the field of cloud computing, enterprise customers may use multiple types of platforms, cloud services, interconnected and/or isolated or on-premise systems. To support such usage, a cloud computing environment must ensure that users have the appropriate access to the right resources.

However, the management of user entitlements, permissions, and security policies across multi-cloud environments presents significant challenges.

For example, entitlement changes such as role updates or permission grants may encounter propagation delays, leading to potential vulnerabilities or mismatches across cloud services. Latency increases the risk of misconfigured permissions, security gaps, or inefficiencies in enforcing access control policies. The security associated with such entitlement changes is also vulnerable to cyberattacks during propagation, potentially exposing sensitive information.

### SUMMARY

In accordance with an embodiment, described herein is a system and method for multi-cloud governance and protection including zero-latency entitlement reconciliation.

The system can be used to address entitlement propagation delays in multi-cloud environments, by leveraging quantum computing techniques and zero-latency synchronization to provide instant updates to permissions and roles across one or more cloud environments while maintaining security for access logs and audit trails.

Embodiments described herein can be used to support applications across various technologies, such as cloud infrastructure entitlement management (CIEM), cloud security posture management (CSPM), or cloud native application protection platform (CNAPP), while providing faster, secure, and highly-scalable cloud governance capabilities.

### BRIEF DESCRIPTION OF THE DRAWINGS

FIG. 1 illustrates an example cloud computing environment, in accordance with an embodiment.

FIG. 2 further illustrates an example cloud computing environment, in accordance with an embodiment.

FIG. 3 further illustrates an example cloud computing environment, in accordance with an embodiment.

FIG. 4 further illustrates an example cloud computing environment, in accordance with an embodiment.

FIG. 5 further illustrates an example cloud computing environment, in accordance with an embodiment.

FIG. 6 further illustrates an example cloud computing environment, in accordance with an embodiment.

FIG. 7 illustrates an example access governance system, for use with a cloud computing environment, in accordance with an embodiment.

FIG. 8 further illustrates an example access governance system, for use with a cloud computing environment, in accordance with an embodiment.

FIG. 9 illustrates the use of multi-cloud governance and protection with a cloud computing environment, in accordance with an embodiment.

FIG. 10 further illustrates the use of multi-cloud governance and protection with a cloud computing environment, in accordance with an embodiment.

FIG. 11 illustrates the use of multi-cloud governance and protection, including zero-latency entitlement reconciliation, in accordance with an embodiment.

FIG. 12 further illustrates the use of multi-cloud governance and protection, including zero-latency entitlement reconciliation, in accordance with an embodiment.

FIG. 13 further illustrates the use of multi-cloud governance and protection, including zero-latency entitlement reconciliation, in accordance with an embodiment.

FIG. 14 further illustrates the use of multi-cloud governance and protection, including zero-latency entitlement reconciliation, in accordance with an embodiment.

FIG. 15 illustrates a process for multi-cloud governance and protection, including zero-latency entitlement reconciliation, in accordance with an embodiment.

### DETAILED DESCRIPTION:

Within the field of cloud computing, enterprise customers may use multiple types of platforms, cloud services, interconnected and/or isolated or on-premise systems. To support such usage, a cloud computing environment must ensure that users have the appropriate access to the right resources.

However, the management of user entitlements, permissions, and security policies across multi-cloud environments presents significant challenges.

For example, entitlement changes such as role updates or permission grants may encounter propagation delays, leading to potential vulnerabilities or mismatches across cloud services. Latency increases the risk of misconfigured permissions, security gaps, or inefficiencies in enforcing access control policies. The security associated with such entitlement changes is also vulnerable to cyberattacks during propagation, potentially exposing sensitive information.

In accordance with an embodiment, described herein is a system and method for multi-cloud governance and protection including zero-latency entitlement reconciliation.

The system can be used to address entitlement propagation delays in multi-cloud environments, by leveraging quantum computing techniques and zero-latency synchronization to provide instant updates to permissions and roles across one or more cloud environments while maintaining security for access logs and audit trails.

Embodiments described herein can be used to support applications across various technologies, such as cloud infrastructure entitlement management (CIEM), cloud security posture management (CSPM), or cloud native application protection platform (CNAPP), while providing faster, secure, and highly-scalable cloud governance capabilities.

### Cloud Computing Environments

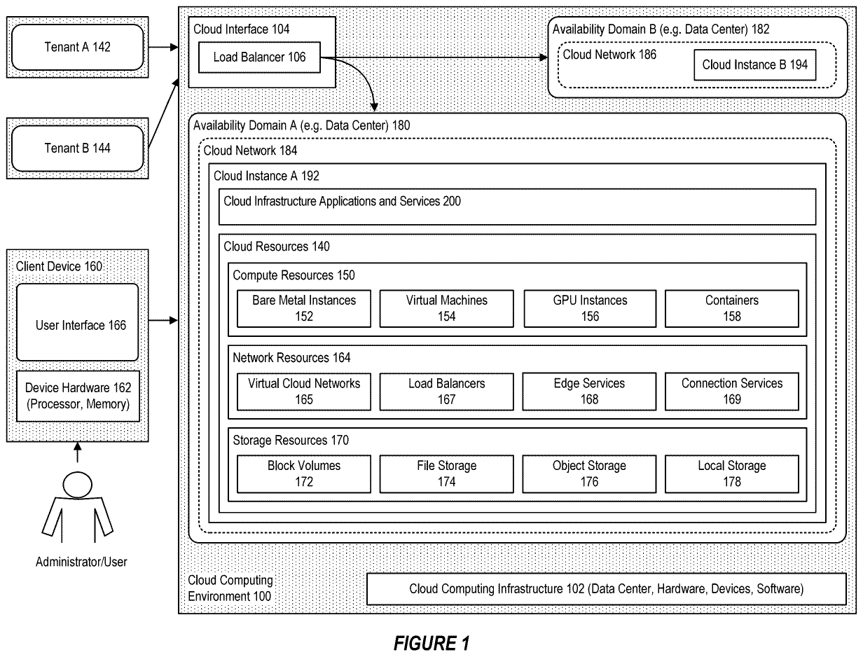

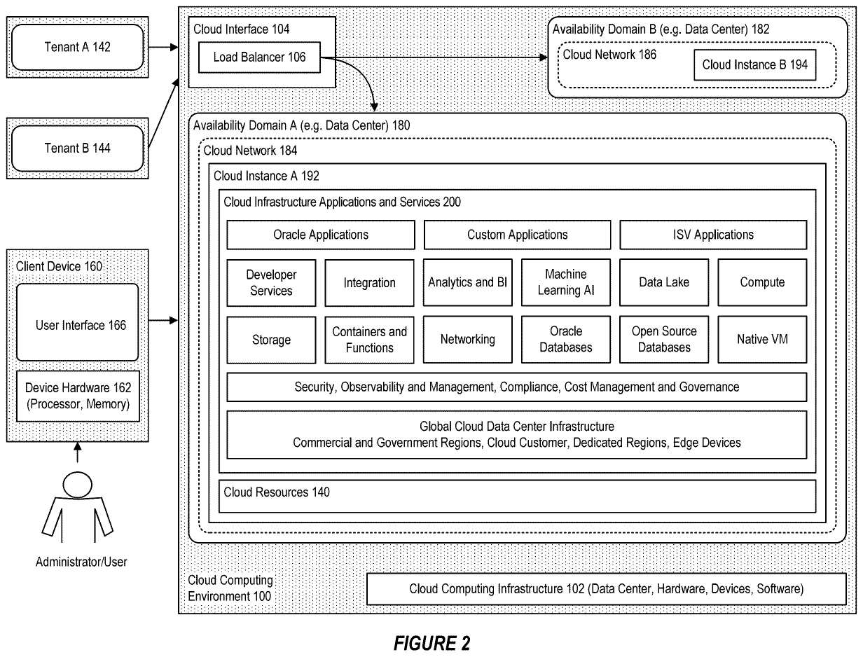

FIGS. 1-2 illustrate an example cloud computing environment, in accordance with an embodiment.

The illustrated example is provided for purposes of illustrating a computing environment for use by tenants of a cloud infrastructure in accessing subscription-based software products, services, or other offerings associated with the cloud environment, and which can be utilized with the systems and methods for multi-cloud governance and protection as described herein. In accordance with other embodiments, the various components, processes, and features described herein for multi-cloud governance and protection can be used with other types of cloud computing environments.

As illustrated in FIG. 1, in accordance with an embodiment, a cloud computing or cloud environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the components and processes illustrated in FIG. 1, and as further described herein with regard to various embodiments, can be provided as software or program code executable by a computer system or other type of processing device, for example a cloud computing system.

In accordance with an embodiment, the cloud environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and isolated partition within the cloud environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud environment via a network such as, for example, a wide area network, local area network, or the Internet, to create or update cloud services.

In accordance with an embodiment, the cloud environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud environment can provide control of physical host (bare metal) machines within the compute resources layer, which run as compute cloud instances directly on bare metal servers, without a hypervisor.

In accordance with an embodiment, the cloud environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud computing environment can include a range of complementary cloud-based components, for example as cloud infrastructure applications and services 200, that enable organizations or enterprise customers to operate their applications and services in a highly-available hosted environment.

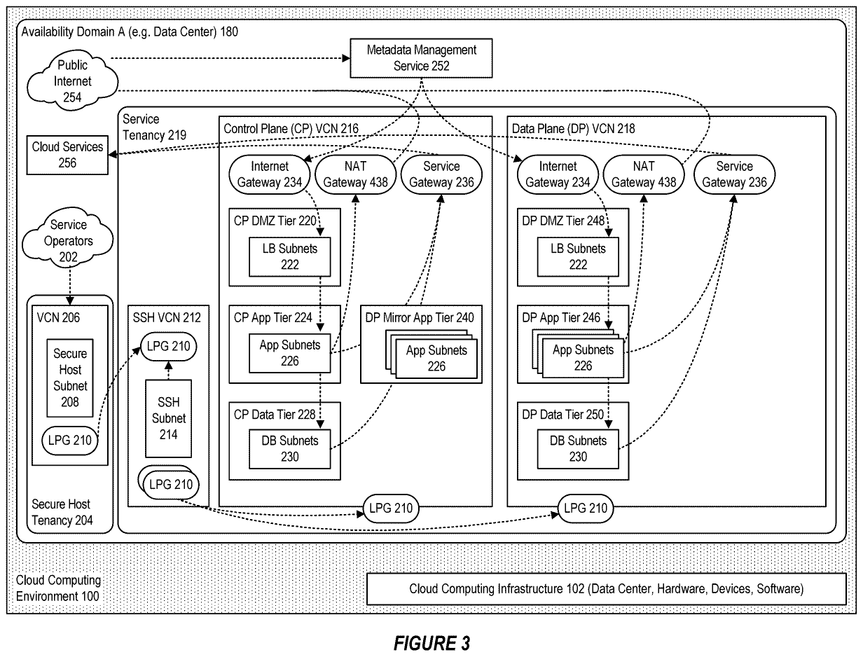

FIGS. 3-6 further illustrate an example cloud computing environment, in accordance with an embodiment.

As noted above, the illustrated example is similarly provided for purposes of illustrating a computing environment which can be utilized with the systems and methods for multi-cloud governance and protection as described herein. In accordance with other embodiments, the various components, processes, and features described herein for multi-cloud governance and protection can be used with other types of cloud computing environments.

As illustrated in FIG. 3, in accordance with an embodiment, service operators 202 can be communicatively coupled to a secure host tenancy 204 that can include a virtual cloud network (VCN) 206 and a secure host subnet 208.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier 246, a data plane DMZ tier 248, and a data plane data tier 250. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way: the service gateway can make API calls to cloud services, and cloud services can send requested data to the service gateway. Generally, cloud services may not initiate API calls to the service gateway.

In accordance with an embodiment, the secure host tenancy can be directly connected to the service tenancy, which may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example create, read, update, or delete (CRUD) operations, through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both of which may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage, which may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infra-structure provider may desire this embodiment since the database(s) that the customers use may be controlled by the cloud infrastructure provider and may be stored on the service tenancy, which may be isolated from the public Internet.

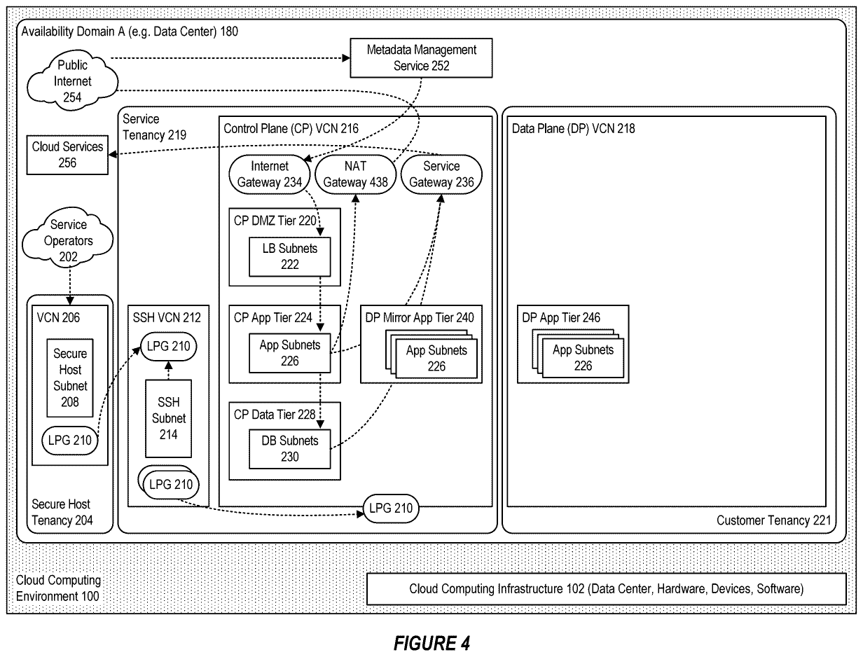

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources that are provisioned in the control plane VCN that is contained in the service tenancy, to be deployed or otherwise used in the data plane VCN that is contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or other-wise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with Deployment 1 in Region 2.

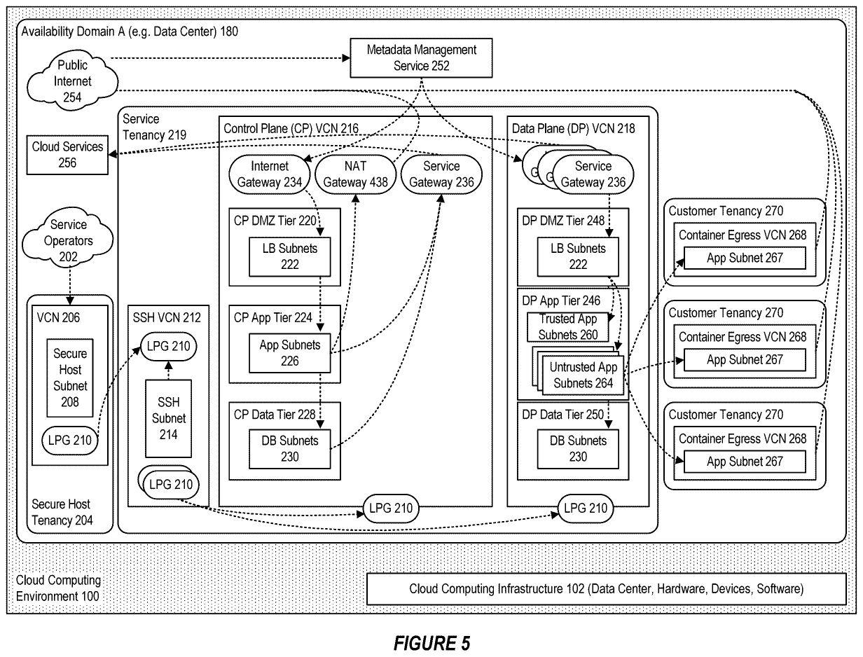

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infra-structure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs, and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)), which may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s), and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled; or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

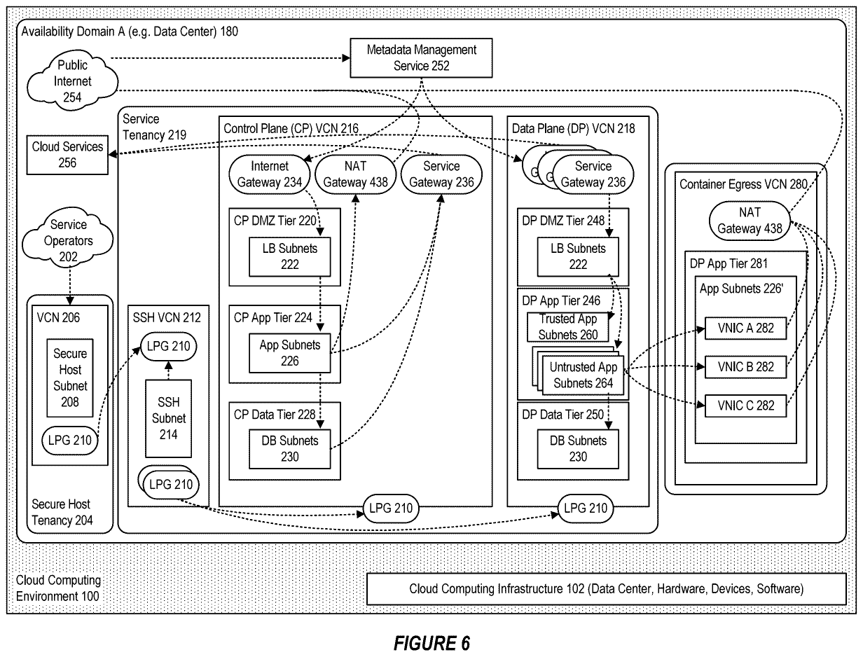

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container, and be communicatively coupled to an app subnet that can be contained in a data plane app tier 281 that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a dis-connected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that requests a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Access Governance

Within the field of cloud computing, enterprise customers may use multiple types of platforms, cloud services, interconnected and/or isolated or on-premise systems. To support such usage, a cloud computing environment must ensure that users have the appropriate access to the right resources.

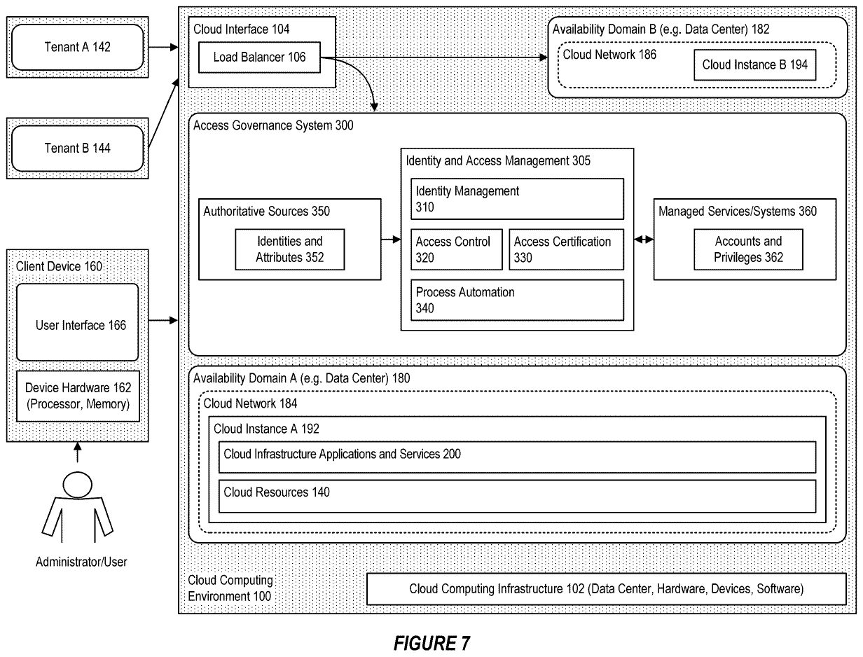

FIG. 7 illustrates an example access governance system, for use with a cloud computing environment, in accordance with an embodiment.

As illustrated in FIG. 7, in accordance with an embodiment, an access governance system 300 can include various components that operate together to provide identity and access management 305, such as, for example: an identity management component 310, that allows an enterprise customer to manage identity and access privileges associated with providing access to resources; an access control component 320 that manages and regulates access permissions within an organization using, for example, role-based access control, or policy-based access control; an access certification component 330 that provides regulatory compliance; and a process automation component 340 for use in managing approval workflows.

In accordance with an embodiment, the access governance system can receive identity related information (e.g., identities and attributes 352) from an authoritative source 350 such as, for example, an Lightweight Directory Access Protocol (LDAP) environment; and can receive access information (e.g., accounts and privileges 362) from managed services/systems 360, such as, for example, an Oracle Database environment.

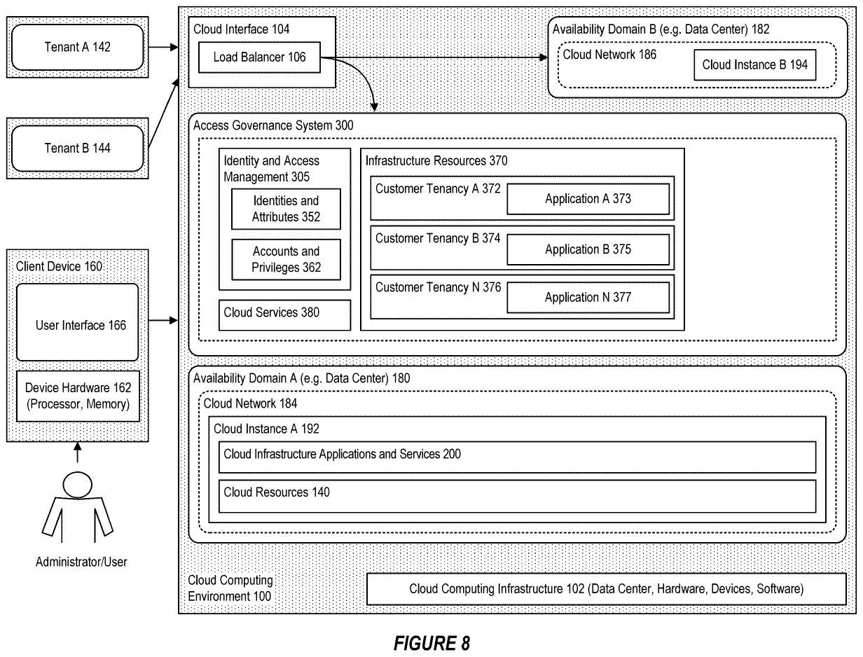

FIG. 8 further illustrates an example access governance system, for use with a cloud computing environment, in accordance with an embodiment.

As illustrated in FIG. 8, in accordance with an embodiment, the access governance system can operate to provide details on, for example, who has access to what, or deter-mine access and permissions for an entity, such as an end user. Cloud infrastructure resources 370, for example hardware and/or software components configurable to provide cloud services 380, can be provided for use by different customer tenancies 372, 374, 376, for use by applications 373, 375, 377 executing therein, for use by cloud customers to address their particular needs.

### Multi-Cloud Governance and Protection

As noted above, within the field of cloud computing, enterprise customers may use multiple types of platforms, cloud services, interconnected and/or isolated or on-premise systems. To support such usage, a cloud computing environment must ensure that users have the appropriate access to the right resources.

However, as noted above, the management of user entitlements, permissions, and security policies across multi-cloud environments presents significant challenges.

For example, entitlement changes such as role updates or permission grants may encounter propagation delays, leading to potential vulnerabilities or mismatches across cloud services. Latency increases the risk of misconfigured permissions, security gaps, or inefficiencies in enforcing access control policies. The security associated with such entitlement changes is also vulnerable to cyberattacks during propagation, potentially exposing sensitive information.

With the rise of multi-cloud strategies, organizations increasingly rely on technologies, such as cloud infrastructure entitlement management (CIEM), cloud security posture management (CSPM), or cloud native application protection platform (CNAPP), to ensure their environments are secure and well-governed. These tools, however, still suffer from latency is-sues due to the asynchronous nature of entitlement updates, misconfigurations, and security policies across diverse cloud platforms.

In accordance with an embodiment, described herein is a system and method for multi-cloud governance and protection including zero-latency entitlement reconciliation.

The system can be used to address entitlement propagation delays in multi-cloud environments, by leveraging quantum computing techniques and zero-latency synchronization to provide instant updates to permissions and roles across one or more cloud environments while maintaining security for access logs and audit trails.

Embodiments described herein can be used to support applications across various technologies, such as cloud infrastructure entitlement management (CIEM), cloud security posture management (CSPM), or cloud native application protection platform (CNAPP), while providing faster, secure, and highly-scalable cloud governance capabilities.

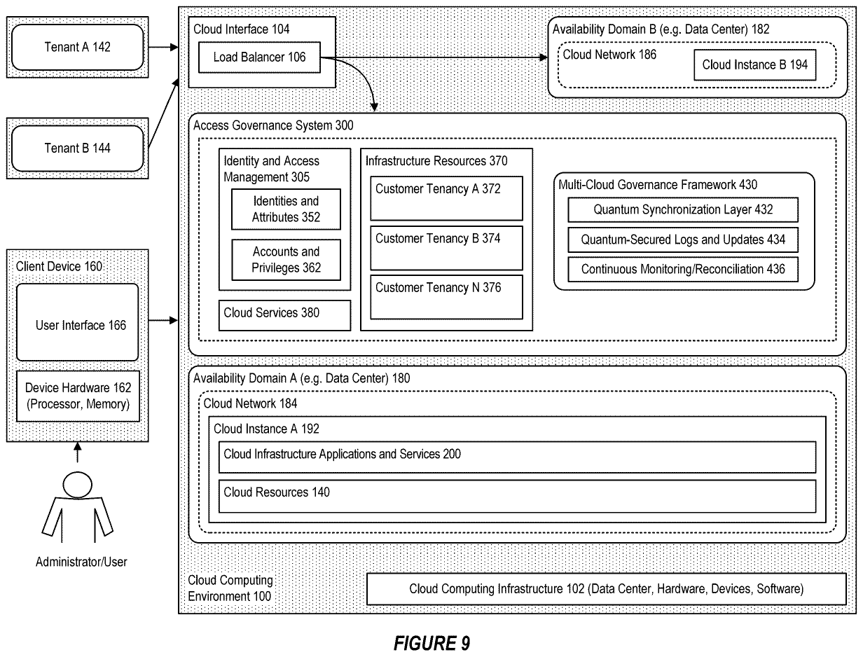

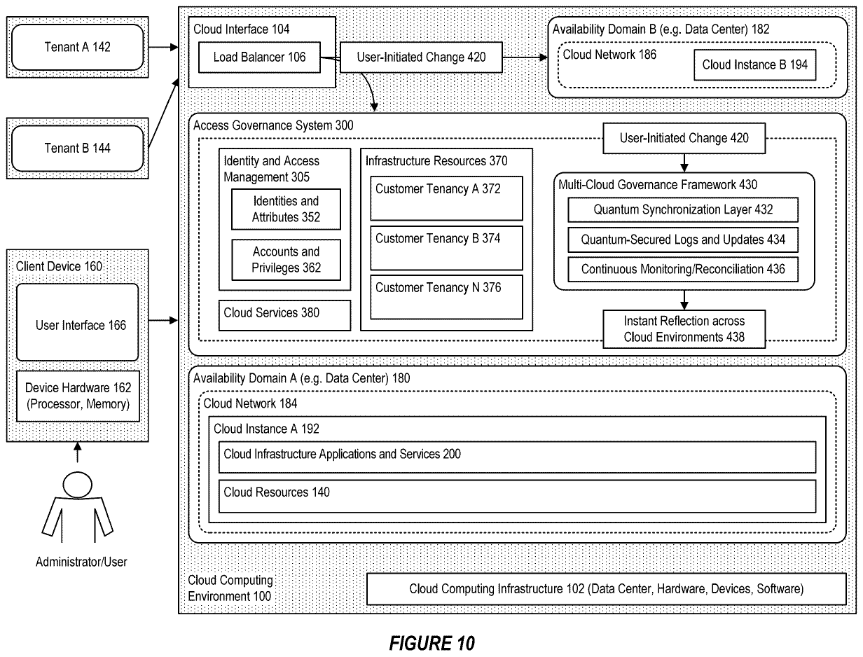

FIGS. 9-10 illustrate the use of multi-cloud governance and protection with a cloud computing environment, in accordance with an embodiment.

As illustrated in FIGS. 9-10 in accordance with an embodiment, the system can provide a multi-cloud governance framework 430 and workflow whereby:

A user initiates a change (420): a user or administrator modifies an entitlement, such as updating a role or revoking access.

Quantum synchronization layer engages (432): the change is immediately captured by the quantum synchronization layer (QSL), which utilizes quantum entanglement to synchronize this update across all connected cloud environments in real time.

Quantum-secured logs and updates (434): as changes propagate instantaneously, quantum cryptography is applied to secure access logs and audit trails, ensuring that all modifications are quantum-resistant to cyber threats.

Instant reflection across clouds (436): all connected cloud platforms (410, 411, 414, 415) instantly reflect the entitlement change, ensuring no discrepancies between environments.

Continuous monitoring and reconciliation (438): the system continuously monitors for any changes in cloud security posture and permissions, using quantum algorithms to instantly reconcile discrepancies or misconfigurations.

In accordance with an embodiment, the system can use quantum entanglement principle that allows quantum states to be instantly correlated regardless of distance. When an entitlement change (such as a permission update) is made, it is immediately mirrored across quantum entangled states representing the user's permissions across multiple cloud environments.

In accordance with an embodiment, quantum cryptography secures the entitlement change process, applying quantum key distribution (QKD) to ensure that only authorized entities can view or modify sensitive data such as access logs or entitlement policies.

In accordance with an embodiment, quantum algorithms enhance the system's ability to detect misconfigurations and security posture anomalies in real-time, applying quantum-enabled pattern recognition to instantly analyze and address security threats across the cloud infrastructure.

In accordance with an embodiment, the system can operate with or otherwise utilize different types of quantum computing systems or hardware to provide various components, processes, and features of the multi-cloud governance framework illustrated above.

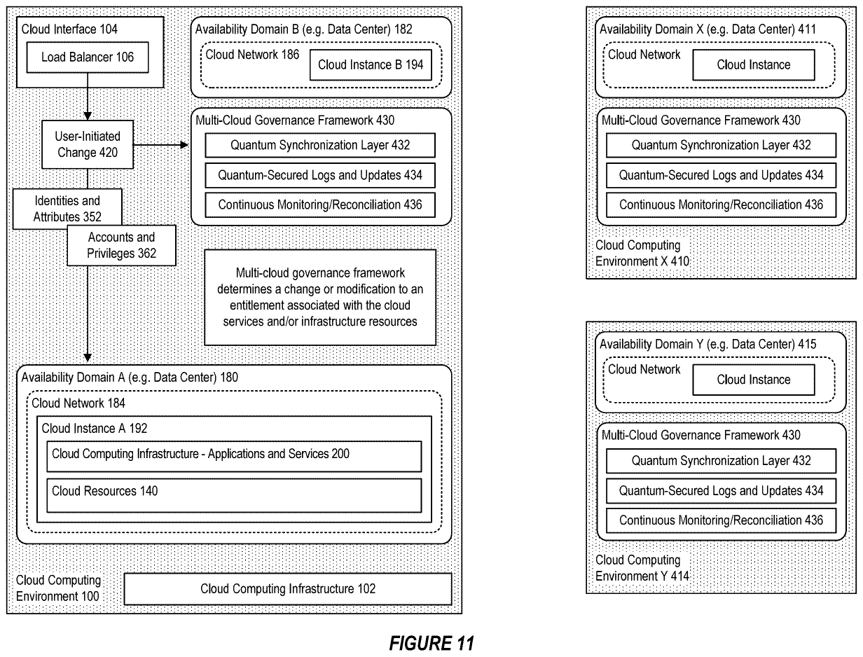

FIG. 11 illustrates the use of multi-cloud governance and protection, including zero-latency entitlement reconciliation, in accordance with an embodiment.

As illustrated in FIG. 11, in accordance with an embodiment, at the first cloud computing environment, the multi-cloud governance framework is operable to determine a change or modification to an entitlement associated with a tenant's use of the cloud services and/or infrastructure resources, including one or more of updating a role or permission.

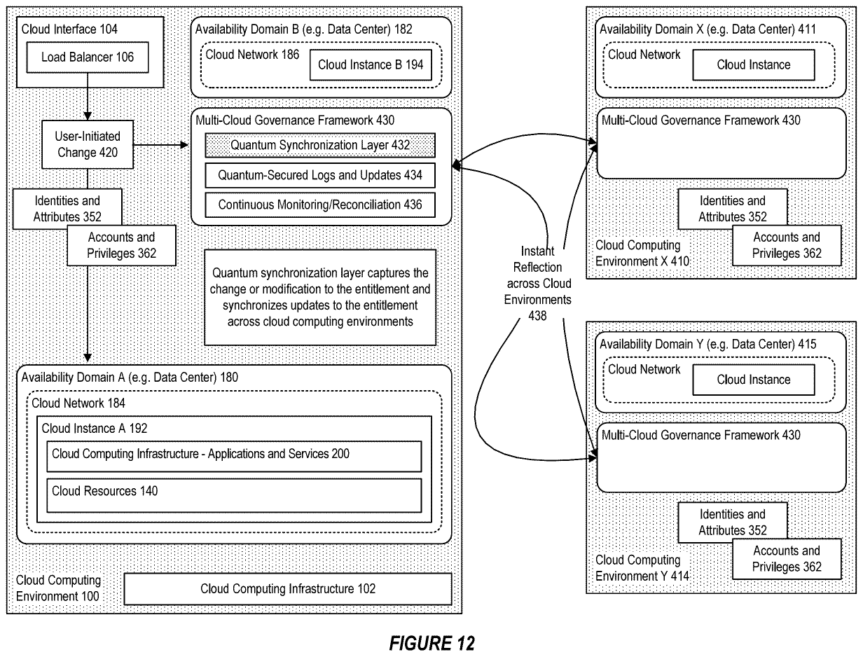

FIG. 12 further illustrates the use of multi-cloud governance and protection, including zero-latency entitlement reconciliation, in accordance with an embodiment.

As illustrated in FIG. 12, in accordance with an embodiment, at the first cloud computing environment, a quantum synchronization layer captures the change or modification to the entitlement and utilizes a process of quantum entanglement to synchronize updates to the entitlement across one or more additional or connected cloud computing environments in real time.

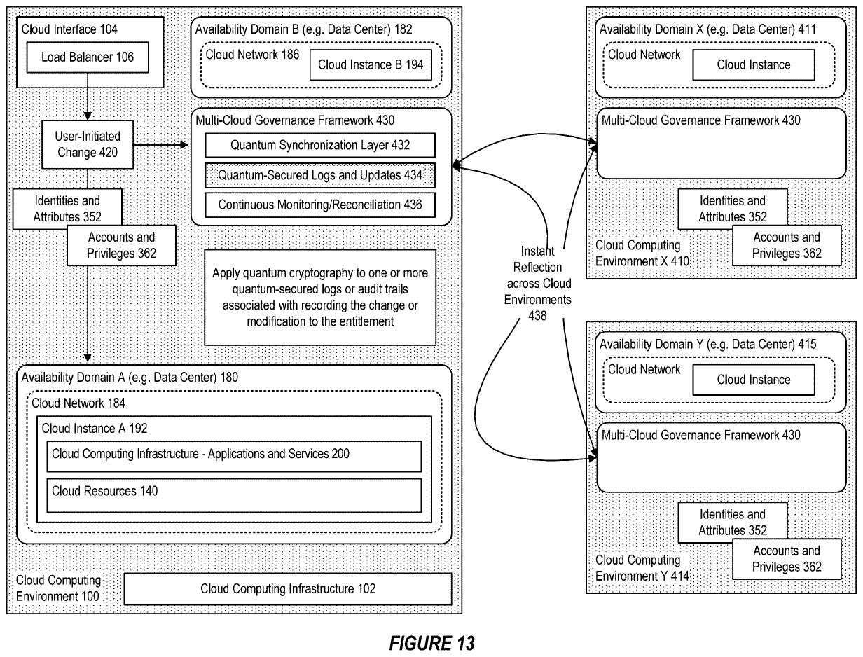

FIG. 13 further illustrates the use of multi-cloud governance and protection, including zero-latency entitlement reconciliation, in accordance with an embodiment.

As illustrated in FIG. 13, in accordance with an embodiment, as the updates to the entitlement are propagated instantaneously between the first cloud computing environment and the additional or connected cloud computing environments, by applying a process of quantum cryptography to one or more quantum-secured logs or audit trails associated with recording the change or modification to the entitlement.

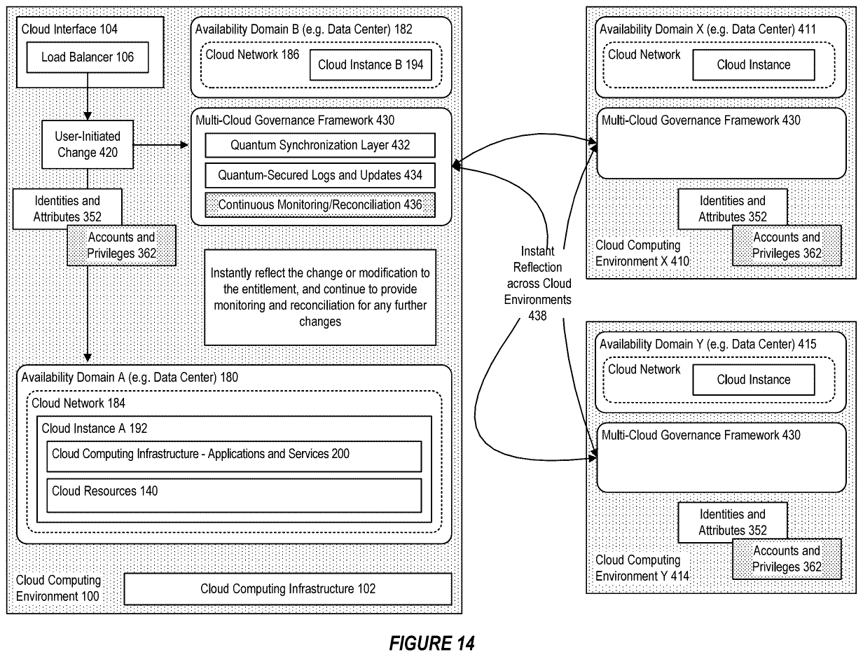

FIG. 14 further illustrates the use of multi-cloud governance and protection, including zero-latency entitlement reconciliation, in accordance with an embodiment.

As illustrated in FIG. 14, in accordance with an embodiment, at each of the additional or connected cloud computing environments, the system instantly reflects the change or modification to the entitlement, ensuring no discrepancies between environments; and continues to provide monitoring and reconciliation for any changes in cloud security posture or permissions.

In accordance with an embodiment, a system or method as described herein comprises: providing, at a cloud computing environment comprising computer hardware and software resources, a plurality of cloud resources or cloud services that operate therein and are associated with entitlements for use therewith; and a multi-cloud governance framework that leverages quantum computing techniques and zero-latency synchronization to provide instant updates to permissions and roles across one or more cloud environments while maintaining security for access logs and audit trails; wherein a change in the entitlements is synchronized, using quantum computing techniques, within or with another cloud environment.

In accordance with an embodiment, the system or method comprises: (a) providing, at a first cloud environment, a plurality of cloud resources or cloud services that operate therein and are associated with a first set of entitlements for use therewith; (b) determining a change in the first set of entitlements; and (c) updating, using a process of quantum entanglement, a second set of entitlements associated with the first set of resources at the first or a second cloud environment.

In accordance with an embodiment, the process of quantum entanglement provides zero-latency synchronization of entitlements, including any permissions or security configurations associated therewith, across multiple different cloud environments.

In accordance with an embodiment, each entitlement, including any permissions or security configurations associated therewith, is represented by one or more quantum bits or qubits, which are entangled across multiple cloud environments, whereupon an update to an entitlement state in the first cloud environment, corresponding qubits are updated in the second cloud environment, to immediately reflect the updated entitlement state.

In accordance with an embodiment, the system is used to provide zero-latency entitlement reconciliation using quantum computing across multiple cloud environments via quantum communication channels established between the multiple cloud environments.

In accordance with an embodiment, to secure communication of entitlement changes, a quantum key distribution process is used to provide a secure exchange of encryption keys between the multiple cloud environments.

### 1. Quantum Entanglement for Instantaneous Mirroring:

In accordance with an embodiment, quantum entanglement is a phenomenon where two or more particles become correlated in such a way that the state of one particle instantly affects the state of the other, regardless of the distance between them. This characteristic allows entangled quantum states to mirror each other instantaneously, bypassing the traditional limits of speed (like those of classical computing and network latency).

### Application in Entitlement Changes:

In accordance with an embodiment, in a multi-cloud environment, each user has specific entitlements (roles, permissions) tied to various resources across cloud platforms. When a change is made to a user's entitlement-such as granting or revoking access-the new state of permissions is represented by an entangled quantum state. This quantum state is instantly correlated with all other corresponding states in other cloud environments.

Thus in accordance with an embodiment, if a user's permissions are updated in a first cloud environment (e.g., OCI), for example, the quantum-entangled states in a second cloud environment will immediately reflect the same update, achieving real-time synchronization. This avoids the delay seen in traditional methods, where each cloud system has to separately process and propagate the changes over API calls.

### 2. Quantum Cryptography for Secured Entitlement Processes:

In accordance with an embodiment, quantum key distribution (QKD) is a highly secure cryptographic protocol used in quantum cryptography. It ensures that encryption keys can be exchanged securely, utilizing the properties of quantum mechanics. An aspect of QKD is that it can detect any eavesdropping attempts due to the disturbance caused in the quantum states, making the communication inherently secure.

### Application in Entitlement Security:

In accordance with an embodiment, during the process of updating entitlements (e.g., role or permission changes), sensitive data such as access logs or security policies is often transferred between cloud environments. By applying quantum key distribution, the system can ensure that only authorized cloud systems and administrators can view or modify these entitlements. Any unauthorized attempt to access the data would disturb the quantum state, instantly signaling a security breach. This ensures secure, tamper-proof communication of entitlement changes across multiple cloud platforms.

In accordance with an embodiment, in addition, all audit trails of access logs can be encrypted using quantum encryption techniques, providing quantum-secured access management to protect sensitive entitlement data.

### 3. Quantum Algorithms for Real-Time Misconfiguration Detection:

In accordance with an embodiment, quantum algorithms are designed to solve problems exponentially faster than classical algorithms by exploiting the principles of superposition and entanglement. For example, algorithms like Grover's Search Algorithm can search un-sorted databases significantly faster than classical algorithms, while Shor's Algorithm can be used for factoring large integers.

### Application in Security Posture Management:

In accordance with an embodiment, quantum algorithms enhance the system's ability to detect misconfigurations, anomalies, or security posture threats in real-time. Since cloud environments are vast and often complex, keeping track of evolving security threats, vulnerabilities, or improper configurations becomes increasingly difficult with classical algorithms.

In accordance with an embodiment, by using quantum-enabled pattern recognition, the system can instantly analyze vast datasets across multi-cloud environments to identify any access control inconsistencies, misconfigured permissions, or security gaps. For example: If there is a misconfiguration in a second cloud environment's role assignment that conflicts with the entitlement settings in a first cloud environment, the quantum system can immediately reconcile the discrepancy by comparing the quantum states of entitlements and instantly updating the incorrect permissions.

### Example Implementation

In accordance with an embodiment, the system can be implemented for entitlement management, as illustrated below.

### 1. Quantum Entanglement:

In accordance with an embodiment, in the context of entitlement changes, the system can operate such that: Entitlement states (permissions, roles, access controls) can be mapped onto quantum states. Each cloud provider has a set of entangled quantum states that represent the entitlement configuration for each user or service. When an entitlement change (such as a permission grant or revocation) is made in a first cloud environment, it instantaneously alters the quantum-entangled states in all connected environments.

### 2. Quantum Entanglement Implementation for Cloud Synchronization:

Quantum Representation of Entitlements: In accordance with an embodiment, each entitlement (permission, role, or policy) is represented by a quantum bit (qubit) or a collection of qubits. For example, a user's access permission to a resource in a first cloud environment could be represented by the state of a quibit (e.g., |0> for “no access” and |1> for “granted access”). These entitlement qubits are entangled across multiple cloud environments. For example, if an entitlement qubit in a first cloud environment is entangled with a qubit in a second cloud environment, any change to the user's access permissions in the first cloud environment will immediately be reflected in the second cloud environment.

Entangling the Qubits Across Clouds: In accordance with an embodiment, quantum channels are established between the cloud environments using quantum communication links (e.g., fiber-optic networks or satellite-based quantum communication systems). These channels are used to entangle the qubits representing entitlements in different cloud environments.

Entangled qubits are distributed between cloud providers. In accordance with an embodiment, once entangled, the state of the qubits in one cloud environment will be inherently linked to the state of the qubits in the other environments.

Instantaneous Entitlement Synchronization: In accordance with an embodiment, when an administrator updates a user's permissions in one cloud (e.g., changing a role in a first cloud environment), the corresponding qubits in the first cloud environment undergo a state change. Due to the entanglement, the qubits in the other clouds that are entangled with the first cloud environment qubits immediately reflect the updated state, ensuring real-time synchronization of the entitlement change. This change bypasses the need for API calls or message exchanges between cloud systems, which traditionally introduce latency.

Quantum Memory and Control: In accordance with an embodiment, quantum memories in each cloud environment store the entangled qubits representing the entitlement states. These quantum memories ensure that the entangled states persist over time, allowing for continuous synchronization of entitlement data. The system uses classical computing systems to manage and monitor the entitlement changes, but the actual synchronization happens via the quantum-entangled qubits.

Error Correction and Stability: Quantum entanglement is inherently fragile, and errors due to noise or decoherence can affect the accuracy of the entitlement synchronization. In accordance with an embodiment, to mitigate this, quantum error correction techniques are employed to ensure that the entangled states remain stable and free from interference over time. Quantum repeaters may be used in long-distance quantum communication networks to boost the entanglement signals, ensuring that they remain coherent across vast distances between cloud data centers.

### 3. Quantum Cryptography and Security:

Quantum Key Distribution (QKD): In accordance with an embodiment, to secure the quantum communication channels and the entitlement change process, QKD is used. QKD allows the secure exchange of encryption keys between cloud environments by leveraging the quantum properties of particles (e.g., photons). Any attempt to intercept or tamper with the communication would disturb the quantum states, alerting the system to a security breach.

In accordance with an embodiment, the quantum-entangled qubits used to represent entitlement states are also inherently secure, as it is impossible to measure a quantum state without disturbing it. This ensures that entitlement data remains tamper-proof across cloud environments.

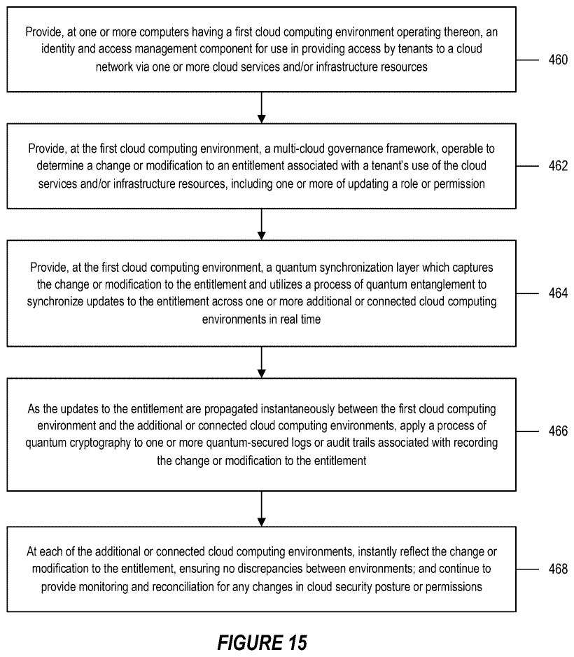

FIG. 15 illustrates a process for multi-cloud governance and protection, including zero-latency entitlement reconciliation, in accordance with an embodiment.

As illustrated in FIG. 15, in accordance with an embodiment, the process comprises, at step 460, providing, at one or more computers having a first cloud computing environment operating thereon, an identity and access management component for use in providing access by tenants to a cloud network via one or more cloud services and/or infrastructure resources.

At step 462, at the first cloud computing environment, a multi-cloud governance framework is provided, operable to determine a change or modification to an entitlement associated with a tenant's use of the cloud services and/or infrastructure resources, including one or more of updating a role or permission.

At step 464, at the first cloud computing environment, a quantum synchronization layer is provided which captures the change or modification to the entitlement and utilizes a process of quantum entanglement to synchronize updates to the entitlement across one or more additional or connected cloud computing environments in real time.

At step 466, as the updates to the entitlement are propagated instantaneously between the first cloud computing environment and the additional or connected cloud computing environments, a process of quantum cryptography is applied to one or more quantum-secured logs or audit trails associated with recording the change or modification to the entitlement.

At step 468, at each of the additional or connected cloud computing environments, the change or modification to the entitlement is instantly reflected, ensuring no discrepancies between environments; and continue to provide monitoring and reconciliation for any changes in cloud security posture or permissions.

### Example Technical Advantages

In accordance with an embodiment, technical advantage including, for example:

Zero latency in entitlement reconciliation: in accordance with an embodiment, by leveraging quantum entanglement, the system ensures instantaneous propagation of entitlement changes across all cloud environments, eliminating delays in permission updates.

Quantum-secured access management: in accordance with an embodiment, using quantum cryptography ensures that sensitive data such as access logs, security policies, and entitlement changes are protected against emerging cyber threats.

Real-time security posture management: in accordance with an embodiment, quantum algorithms monitor and correct security posture across clouds in real time, enhancing an organization's overall security stance.

Scalability across multi-cloud environments: in accordance with an embodiment, the system can easily scale across multiple cloud providers, ensuring uniformity in entitlement management and cloud security configurations.

In accordance with various embodiments, the systems and methods described herein can be implemented using one or more computer, computing device, machine, or micro-processor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for multi-cloud governance and protection including zero-latency entitlement reconciliation, comprising:
providing, at a cloud computing environment comprising computer hardware and software resources, a plurality of cloud resources or cloud services that operate therein and are associated with entitlements for use therewith; and
a multi-cloud governance framework that leverages quantum computing techniques and zero-latency synchronization to provide instant updates to permissions and roles across one or more cloud environments while maintaining security for access logs and audit trails;
wherein a change in the entitlements is synchronized, using quantum computing techniques, within or with another cloud environment.

2. The system of claim 1, further comprising:
(a) providing, at a first cloud environment, a plurality of cloud resources or cloud services that operate therein and are associated with a first set of entitlements for use therewith;
(b) determining a change in the first set of entitlements; and
(c) updating, using a process of quantum entanglement, a second set of entitlements associated with the first set of resources at the first or a second cloud environment.

3. The system of claim 1, wherein the process of quantum entanglement provides zero-latency synchronization of entitlements, including any permissions or security configurations associated therewith, across multiple different cloud environments.

4. The system of claim 1, wherein each entitlement, including any permissions or security configurations associated therewith, is represented by one or more quantum bits or qubits, which are entangled across multiple cloud environments, whereupon an update to an entitlement state in the first cloud environment, corresponding qubits are updated in the second cloud environment, to immediately reflect the updated entitlement state.

5. The system of claim 1, wherein the system is used to provide zero-latency entitlement reconciliation using quantum computing across multiple cloud environments via quantum communication channels established between the multiple cloud environments.

6. The system of claim 1, wherein to secure communication of entitlement changes, a quantum key distribution process is used to provide a secure exchange of encryption keys between the multiple cloud environments.

7. A method for multi-cloud governance and protection including zero-latency entitlement reconciliation, comprising:
providing, at a cloud computing environment comprising computer hardware and software resources, a plurality of cloud resources or cloud services that operate therein and are associated with entitlements for use therewith;
providing a multi-cloud governance framework that leverages quantum computing techniques and zero-latency synchronization to provide instant updates to permissions and roles across one or more cloud environments while maintaining security for access logs and audit trails; and
synchronizing a change in the entitlements, using quantum computing techniques, within or with another cloud environment.

8. The method of claim 7, further comprising:
(a) providing, at a first cloud environment, a plurality of cloud resources or cloud services that operate therein and are associated with a first set of entitlements for use therewith;
(b) determining a change in the first set of entitlements; and
(c) updating, using a process of quantum entanglement, a second set of entitlements associated with the first set of resources at the first or a second cloud environment.

9. The method of claim 7, wherein the process of quantum entanglement provides zero-latency synchronization of entitlements, including any permissions or security configurations associated therewith, across multiple different cloud environments.

10. The method of claim 7, wherein each entitlement, including any permissions or security configurations associated therewith, is represented by one or more quantum bits or qubits, which are entangled across multiple cloud environments, whereupon an update to an entitlement state in the first cloud environment, corresponding qubits are updated in the second cloud environment, to immediately reflect the updated entitlement state.

11. The method of claim 7, wherein the method is used to provide zero-latency entitlement reconciliation using quantum computing across multiple cloud environments via quantum communication channels established between the multiple cloud environments.

12. The method of claim 7, wherein to secure communication of entitlement changes, a quantum key distribution process is used to provide a secure exchange of encryption keys between the multiple cloud environments.

13. A non-transitory computer readable storage medium, including instructions stored thereon which when read and executed by one or more computers cause the one or more computers to perform a method comprising:
providing, at a cloud computing environment comprising computer hardware and software resources, a plurality of cloud resources or cloud services that operate therein and are associated with entitlements for use therewith;
providing a multi-cloud governance framework that leverages quantum computing techniques and zero-latency synchronization to provide instant updates to permissions and roles across one or more cloud environments while maintaining security for access logs and audit trails; and
synchronizing a change in the entitlements, using quantum computing techniques, within or with another cloud environment.

14. The non-transitory computer readable storage medium of claim 13, wherein the method further comprises:
(a) providing, at a first cloud environment, a plurality of cloud resources or cloud services that operate therein and are associated with a first set of entitlements for use therewith;
(b) determining a change in the first set of entitlements; and
(c) updating, using a process of quantum entanglement, a second set of entitlements associated with the first set of resources at the first or a second cloud environment.

15. The non-transitory computer readable storage medium of claim 13, wherein the process of quantum entanglement provides zero-latency synchronization of entitlements, including any permissions or security configurations associated therewith, across multiple different cloud environments.

16. The non-transitory computer readable storage medium of claim 13, wherein each entitlement, including any permissions or security configurations associated therewith, is represented by one or more quantum bits or qubits, which are entangled across multiple cloud environments, whereupon an update to an entitlement state in the first cloud environment, corresponding qubits are updated in the second cloud environment, to immediately reflect the updated entitlement state.

17. The non-transitory computer readable storage medium of claim 13, wherein the method is used to provide zero-latency entitlement reconciliation using quantum computing across multiple cloud environments via quantum communication channels established between the multiple cloud environments.

18. The non-transitory computer readable storage medium of claim 13, wherein to secure communication of entitlement changes, a quantum key distribution process is used to provide a secure exchange of encryption keys between the multiple cloud environments.
